(19) United States
(12) Patent Application Publication
(10) Pub. No.: US 2002/0112162 A1
(43) Pub. Date: Aug. 15, 2002

(54) Authentication and verification of Web page content

(76) Inventors: Thomas Andrew Cocotis, Huntington Beach, CA (US); David Neil Dyrnaes, Newport Coast, CA (US); Craig Evan Trivelpiece, Newport Beach, CA (US)

Correspondence Address: SIDLEY AUSTIN BROWN & WOOD LLP, 717 NORTH HARWOOD, SUITE 3400, DALLAS, TX, 75201, US

(21) Appl. No.: 09/782,645

(22) Filed: Feb. 13, 2001

(51) Int. Cl. H04L 9/00

(52) U.S. Cl. 713/176

(57) ABSTRACT

Authentication and verification of the integrity of multimedia content delivered from a server to a client through a computer network, such as the Internet, provides a substantial reduction in the possibility of inaccurate and/or unintended content being displayed to a user. Each content file stored on the server is cryptographically registered and such registration information is stored on the server along with the corresponding file name. A user is provided with a second (e.g., public) key corresponding to a first (e.g., private) key used to cryptographically register the content files.

Through a consumer application such as a Web browser, the user instructs the client to request Web content from the server. The server assembles a list of the content files necessary to satisfy the request and transmits the list to the client. Prior to transmitting the actual content files, the server transmits to the client the registration information for these content files. The client uses the second key to validate the cryptographic registration information for any listed content files already resident locally. If the registration information for any files can be successfully validated, then those files have been authenticated and verified and do not need to be transmitted from the server. The server then transmits the actual content files for those files not yet authenticated and verified at the client. The client again uses the second key to validate the cryptographic registration information for the content files received from the server. If the registration information for all of the files is successfully validated, then the client displays the Web page. If any files cannot be successfully validated, then the client will not display any portion of the Web page.

### TECHNICAL FIELD OF THE INVENTION

The present invention pertains in general to delivering and displaying multimedia content through the Internet and in particular to a technique for authenticating and verifying the integrity of Web page content prior to display.

### BACKGROUND OF THE INVENTION

In order to facilitate an understanding of how computer networks allow for the transfer of data a brief discussion about such networks is provided. Computers and computer networks are used to exchange information in many fields such as media, commerce, and telecommunications, for example. The exchange of information between computers typically occurs between a “server application” that provides information or services, and a “client application” or device that receives the provided information and services. Multiple server applications are sometimes available on a “system server” such as a single computer server that provides services for multiple clients. Alternatively, distributed server systems allow a single client to obtain services from applications residing on multiple servers. For example, in current distributed server systems, client applications are enabled to communicate with server applications executing on the same computer system or on another computer system accessible via a network, for instance via the Internet.

The Internet is a worldwide network of interconnected computers. A client (computer) accesses a server (computer) on the network via an Internet provider. An Internet provider is an organization that provides a client (computer) with access to the Internet (via analog telephone line or Integrated Services Digital Network line, for example). A client can, for example, read information from, download a file from, or send an electronic mail message to another computer/client using the Internet.

To retrieve a file or service on the Internet, a client must typically search for the file or service, make a connection to the computer on which the file or service is stored, and download the file or access the service. Each of these steps may involve a separate application and access to multiple, dissimilar computer systems (e.g. computer systems having different operating systems). The World Wide Web (the Web) was developed to provide a simpler, more uniform means for accessing information on the Internet.

The components of the Web include browser software, network links, servers, and Web protocols. The browser software, or browser, is a tool for displaying a user-friendly interface (i.e., front-end) that simplifies user access to content (information and services) on the Web. Depending on the Web browser and/or the functionality required, it may be necessary to utilize a plug-in application, an applet, an Active-X control, or other applications in combination with the Web browser (it is also possible to integrate such functions into the Web browser itself). Browsers use standard Web protocols to access content on remote computers running Web server processes. A browser allows a user to communicate a request from a client to a Web server without having to use the more obscure addressing scheme of the underlying Internet. A browser typically provides a graphical user interface (GUI) for displaying information and receiving input through the client. Examples of browsers currently available include Netscape Navigator and Communicator, and Microsoft Internet Explorer.

Web browsers and servers communicate over network links using standardized message formats call protocols. The most common modem protocol is TCP/IP (Transmission Control Protocol/Internet Protocol) protocol suite. The protocols are based on the OSI (Open Systems Interconnect) seven-layered network communication model. Web messages are primarily encoded using Hypertext Transport Protocol (HTTP). HTTP constitutes the (top) Application layer of the OSI model. Application layer protocols facilitate remote access and resource sharing and are supported by the reliable communications ensured by the lower layers of the communications model. Therefore, HTTP simplifies remote access and resource sharing between clients and servers while providing reliable messaging on the Web.

Information servers maintain the information on the Web and are capable of processing client requests. HTTP has communication techniques that allow clients to request data from a server and send information to the server.

To submit a request, the client (via the browser) contacts the HTTP server and transmits the request to the HTTP server. The request contains the communication technique requested for the transaction (e.g., GET an object from the server or POST data to an object on the server). The HTTP server responds to the client by sending a status of the request and the requested information. The connection is then terminated between the client and the HTTP server.

A client request, therefore, consists of establishing a connection between the client and the HTTP server, performing the request, and terminating the connection. The HTTP server typically does not retain any information about the request after the connection has been terminated. That is, a client can make several requests of an HTTP server, but each individual request is treated independent of any other request.

The Web employs an addressing scheme that uniquely identifies Internet resources (e.g., HTTP server, file, or program) to clients and servers. This addressing scheme is called the Uniform Resource Locator (URL). A URL represents the Internet address of a resource on the Web. The URL contains information about the protocol, Internet domain name and addressing port of the site on which the server is running. It also identifies the location of the resource in the file structure of the server.

HTTP provides a mechanism of associating a URL address with active text. A browser generally displays active text as underlined and color-coded. When activated (by a mouse click, for example) the active text causes the browser to send a client request for a resource to the server indicated in the text's associated URL address. This mechanism is called a hyperlink. Hyperlinks provide the ability to create links within a document to move directly to other information. A hyperlink can request information stored on the current server or information from a remote server.

If the client requests a file, the HTTP server locates the file and sends it to the client. An HTTP server also has the ability to delegate work to gateway programs. The Common Gateway Interface (CGI) specification defines a mechanism by which HTTP servers communicate with gateway programs. A gateway program is referenced using a URL. The HTTP server activates the program specified in the URL and uses CGI mechanisms to pass program data sent by the client to the gateway program. Data is passed from the server to the gateway program via command-line arguments, standard input, or environment variables. The gateway program processes the data and returns its response to the server using CGI (via standard output, for example). The server forwards the data to the client using the HTTP.

When a browser displays information to a user it is typically as pages or documents (referred to as “Web pages”). The document encoding language used to define the format for display of a Web page is called Hypertext Markup Language (HTML). A server sends a Web page to a client in HTML format. The browser program interprets the HTML and displays the Web page in a format based on the control tag information in the HTML.

As discussed above, the standard practice is that the user enters a request into the Web browser installed on the client, the client (via the browser) sends a request for information to the server, the server retrieves the requested information from its stored database of information, the server transmits the requested information to the client, and finally the client (via the browser or an associated application) displays the requested information to the user. The requested information can be any type of multimedia content, including but not limited to text, graphics, sound, and/or video. Using current technology, no steps are taken to verify or authenticate the validity of the multimedia content that is ultimately displayed to the user.

Various techniques are known for ensuring the security of a server, but providing such server security does not necessarily ensure that the user will ultimately receive and display only the intended content. If the server is hacked (accessed without permission of the server operator), or if there is malicious or accidental internal corruption at the server and/or the client, then it is possible that unintended content will be displayed to the user. Furthermore, if there is data corruption during data transmission, the content displayed to the user will not be as intended. Intentional or unintentional changes to the directory or file names in which the content is located can also make undesired changes to the content ultimately displayed to the user. In other words, even if the server is secured against hacking, the prior art technology still fails to prevent the many possible ways in which unintended content can be displayed to the user.

Thus there is a need for greater security for data transmitted through a network.

### SUMMARY OF THE INVENTION

A selected embodiment of the present invention is a technique for securely delivering multimedia content through a public computer network, such as the Internet. In one embodiment, the present invention provides a technique for securely delivering Web page content from a first computer (e.g., a server computer) to a second computer (e.g., a client computer) through, for example, the Internet to ensure that only the intended content is displayed to the user. The Web page content may be a text file, graphics file, multimedia file, etc. First, each file contained within a database of files on the server is registered. For registration, a unique digital signature is generated using a key (e.g, a private key in a public key/private key pair). Each unique digital signature is then stored on the server, along with a corresponding file name for the file.

When the user enters a request into a Web browser installed on the client, the client (using the combined functionality of the client and the browser and any other necessary applications such as a plug-in, an applet, or an Active-X control) transmits a corresponding request to the server. The server receives this request and assembles a list of the one or more files necessary to satisfy the client's request. The server then transmits to the client the files contained in this list, along with the corresponding digital signature for each file in the list. Using a public key corresponding to the private key used by the server, the client validates the digital signature for each file received from the server (this validation can utilize, for example, either an RSA or a DSA type of digital signature technique). Note that any type of digital signature technique can be used. If the digital signature for each file in the list is validated, then the client builds a Web page from the files received from the server and displays it to a user. If the digital signature for any one of the files in the list is not validated, then the client does not build or display the Web page. Instead, the client displays an error message to the user and repeats the request to the server so that the process can be repeated for any files whose digital signatures were not successfully validated.

In another aspect of the invention, the delivery of content is made more efficient by avoiding the delivery of files already stored locally if such files can be authenticated and verified by the client. In this embodiment, the server transmits to the client the list of files necessary to satisfy the client's request and the corresponding digital signatures for each such file, but the server does not immediately send the files themselves. Instead, the client checks to determine if any of the listed files are already stored locally. For any listed files that are stored locally, the client validates the digital signature for each such file using a public key corresponding to the private key used by the server (again, it is not critical whether this validation utilizes an RSA or a DSA or other type of digital signature technique). If any file has a digital signature which is successfully validated, the client removes the file from the list assembled by the server. For any file whose digital signature is not validated, such file remains on the list assembled by the client and, depending on the embodiment, the client may or may not delete such file from the client's local storage. The client then transmits the modified list back to the server such that the server can transmit to the client the files remaining on the modified list. At that point, the client validates the digital signatures to authenticate and verify the files transmitted by the server. Finally, if the digital signature corresponding to each necessary file has been successfully validated (and thus authenticated and verified), then the client builds the web page from the files previously stored locally and the files received from the server, thereby displaying the desired web page to the user.

In another aspect of the invention, additional authentication and verification occurs at the server prior to responding to the client's request for content. During registration of each content file contained in the database of files on the server, the server uses the private key to generate and store a server digital signature of the content file itself and then to generate and store a secondary digital signature of the server digital signature and the name of the content file. Later, when the server receives the client's request for content and assembles a list of the files necessary to satisfy the client's request, the server authenticates and verifies that the stored content files to be retrieved are the same as the content files originally registered. Specifically, the server uses a public key to validate the server digital signature and the secondary digital signature for each file. If any of these digital signatures are not successfully validated, then no content files will be transmitted and/or displayed to the user.

### BRIEF DESCRIPTION OF THE DRAWINGS

For a more complete understanding of the present invention and the advantages thereof, reference is now made to the following description taken in conjunction with the accompanying drawings in which:

FIG. 1 is a schematic illustration of a network showing entities and relationships of an embodiment of the present invention;

FIG. 2 is a state diagram illustrating the dataflow and functions performed with respect to each of the entities shown in FIG. 1;

FIG. 3 is a flow chart illustrating the decision process utilized by the client according to one embodiment of the present invention which authenticates and verifies the integrity of files in a serial progression;

FIG. 4 is a flow chart illustrating the process utilized by the client according to another embodiment of the present invention which authenticates and verifies the integrity of any files stored locally prior to receiving files from the server computer; and

FIG. 5 is a flow chart illustrating the decision process utilized by the client according to another embodiment of the present invention which authenticates and verifies the integrity of files in a parallel progression.

### DETAILED DESCRIPTION

In conventional browser technology, no verification or authentication is performed to ensure the validity of graphics or other multimedia content that are displayed to the user. In other words, the conventional technology does not provide any safeguards to ensure that the content displayed to the user is exactly the same as the content originally stored on the Web server. Although there are various techniques for hardening (i.e., securing) a Web server to protect it from attack, there is no way to guarantee that it will not be hacked or will not suffer malicious or accidental internal corruption. The probable result of such hacking or corruption is that unintended graphics or other multimedia content will be displayed to the user. As a result, conventional technology provides no way to guarantee that a user will display only the intended content. Of particular concern in the field of electronic commerce, there is no way for a third party service provider to guarantee to its partners that the graphics and other content provided by the partners are the graphics and content that will ultimately be displayed to the user. For instance, simple changes in directory or file names can change the graphics and other content that is displayed.

One possible solution to this problem is to store content files without digital signatures and to digitally sign each content file immediately prior to transmitting it from the Web server, and then to authenticate and verify (i.e., validate) the digital signature of each file received by the client prior to displaying such content. However, this solution is still subject to hacking and does not protect against renaming the file names. Also, this solution places a large computational burden on the server.

The present invention is directed to a technique for accurately authenticating and verifying the validity of content files sent by a Web server, received by a client, and displayed by a user. One advantage of the present invention is to provide such authentication and verification without unduly burdening the server with having to validate cryptographic digital signatures with each usage. Another advantage is to improve the speed and efficiency of the server by preventing the transmission of content files that are already resident in the client's local storage and can be authenticated and verified.

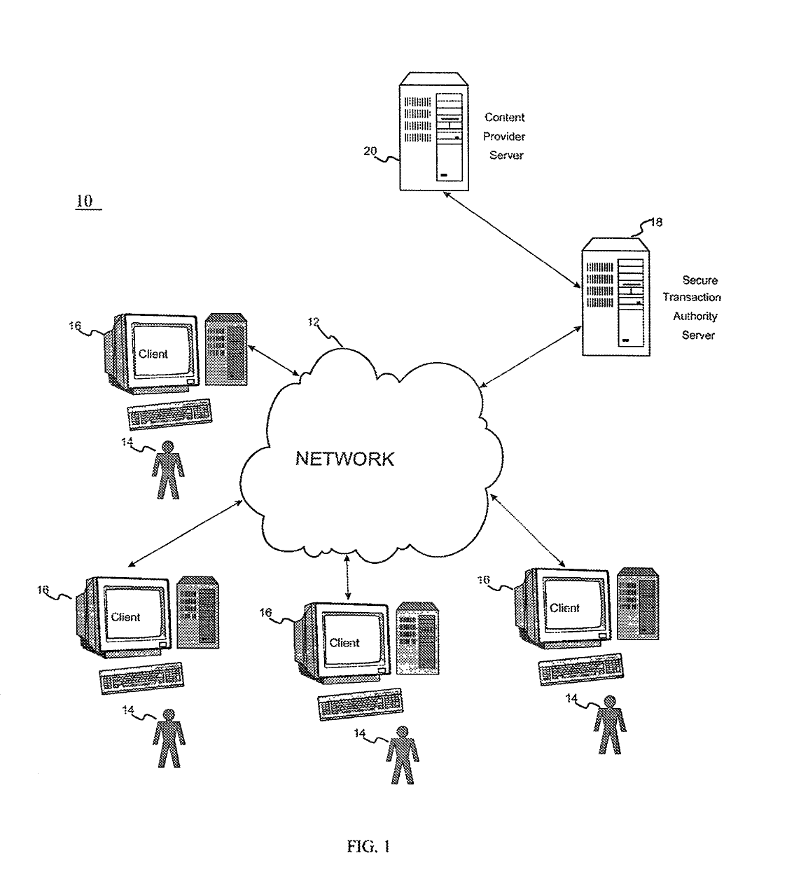

Referring to FIG. 1, there is illustrated a network 10 that demonstrates the interaction of the entities and systems involved in an embodiment of the present invention. The communication between the entities is provided by a communications network 12, such as the Internet. A user 14, such as an individual consumer, uses a client 16 which is connected to and communicates with a secure transaction authority (STA) server 18 through the Network 12. By communicating with server 18, user 14 is able to request, receive, and display graphics (and multimedia content in general) stored and transmitted by server 18. The present invention is also applicable to text, audio and other types of multimedia data. In this invention, the content offered by server 18 can originate with the entity which operates and maintains server 18. However, in the embodiment illustrated, the content securely transmitted from server 18 to client 16 originates with a content provider server 20 which desires to ensure the accuracy of the content ultimately displayed to user 14.

It is important to note that an embodiment of the invention refers to operations performed by client 16. In operation, a Web browser or other consumer software application is installed on client 16 which permits client 16 to perform such operations (for example, communicating with server 18 through the Network 20, generating and verifying digital signatures, etc.). This functionality of the Web browser can be provided by a plug-in, an applet, an Active-X control, or some similar application integrated into the Web browser. As a result, it should be understood that references to operations performed by client 16 are actually performed using the combined functionality of client 16 and the Web browser or other software applications integrated into the Web browser or installed on client 16.

Embodiments of the invention also refer to various techniques of generating and validating digital signatures. In particular, this invention is equally applicable when utilizing RSA or DSA digital signature techniques. Generally speaking, the RSA technique uses a hash function to generate a message digest (i.e., a hash) of the content and then uses a private key to produce a “digital signature” by encrypting such message digest. After the message and digital signature are sent, the receiver uses the same hash function to generate a message digest (i.e., a hash) and uses a public key corresponding to the private key to decrypt the digital signature. If the receiver's message digest matches the decrypted digital signature, then the digital signature has been validated. The DSA technique, on the other hand, uses a private key, a hash function, and the content to generate a digital signature. After the message and digital signature are sent, the receiver uses a corresponding public key, a hash function, and the content to generate a message digest. If the receiver's message digest matches the digital signature, then the digital signature has been validated.

It is not critical to the present invention whether the RSA or the DSA technique is used to authenticate and verify (i.e., validate) the digital signature, or whether some other technique of validating digital signatures is utilized. Accordingly, when the term “validate” is used in this patent, it is intended to encompass both the RSA and the DSA techniques and/or any other technique of authenticating and verifying digital signatures.

Each computer, client or server, generally includes, inter alia, a processor, random access memory (RAM), one or more data storage devices (e.g., hard, floppy, and/or CD-ROM disk drives, etc.), one or more data communications devices (e.g., modems, network interfaces, etc.), a monitor (e.g., CRT, LCD display, etc.), an input device (e.g., a mouse and/or a keyboard). It is envisioned that attached to each computer may be other devices such as read only memory (ROM), a video card, bus interface, printers, etc. Those skilled in the art will recognize that any combination of the above components, or any number of different components, peripherals, and other devices, may be used with each computer.

Each computer operates under the control of an operating system (OS), such as AIX®, WINDOWS NT®, UNIX®, etc. At each computer, the operating system is booted into the memory of the computer for execution when the computer is powered-on or reset. In turn, the operating system then controls the execution of one or more computer programs by the computer. The present invention is generally implemented in these computer programs, which execute under the control of the operating system and cause the computer to perform the desired functions as described herein.

The operating system and computer programs are comprised of instructions which, when read and executed by the computer, causes the computer to perform the steps necessary to implement and/or use the present invention. Generally, the operating system and/or computer programs are tangibly embodied in and/or readable from a device, carrier, or media, such as memory, data storage devices, and/or a remote device coupled to the computer via the data communications devices. Under control of the operating system, the computer programs may be loaded from the memory, data storage devices, and/or remote devices into the memory of the computer for use during actual operations.

Thus, the present invention may be implemented as a method, apparatus, or article of manufacture using standard programming and/or engineering techniques to produce software, firmware, hardware, or any combination thereof. The term “article of manufacture” (or alternatively, “computer program product”) as used herein is intended to encompass a computer program accessible from any computer-readable device, carrier, or media. Of course, those skilled in the art will recognize many modifications may be made to this configuration without departing from the scope of the present invention.

Those skilled in the art will recognize that the exemplary environment illustrated in FIG. 1 is not intended to limit the present invention. Indeed, those skilled in the art will recognize that other alternative hardware environments may be used without departing from the scope of the present invention.

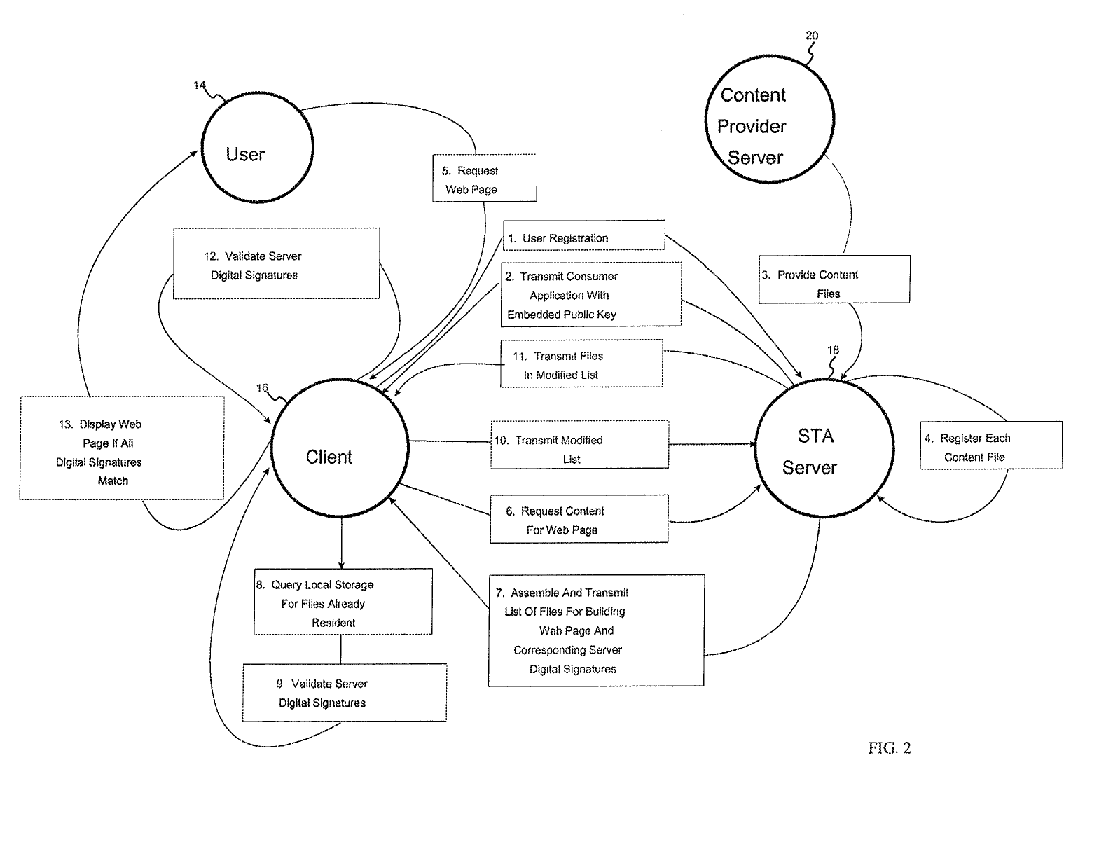

Referring now to FIG. 2, there is illustrated a state diagram and functional which includes user 14, client 16, server 18, and content provider server 20. The sequence of operations performed in this state diagram are as follows:

1. User Registration

Once a user 14 decides he/she would like to access the goods, services, or information being offered via the server 18, the user 14 must initiate a registration procedure to be eligible. The information required from the user 14 during this registration procedure depends on the application for which registration is sought, but such specific information is not critical to the present invention. It is only necessary that the user 14 notify the server 18 of his/her interest in accessing the offered goods, services, or information.

2. Transmit Consumer Application with Embedded Public Key

The server 18 then transmits an appropriate consumer application to the user 14 such that the user 14 can install the consumer application on the client 16. The consumer application allows the client 16 to communicate with the server 18 and can be a plug-in program for a web browser. In addition, the consumer application contains an embedded public key which corresponds with a private key to be used by the server 18 for generating digital signatures. In fact, if the client 16 already has a consumer application which is capable of communicating with the server 18, then it is only necessary that the client 16 be able to access a public key corresponding to the private key used by the server 18. A common technique for transmitting public keys and other information necessary to validate digital signatures transmitted to and from Web browsers is by transmitting a digital certificate. Accordingly, a digital certificate can also be used with this invention.

3. Provide Content Files

The content provider server 20 transmits to the server 18 the computer files containing the content it wishes to make available to users 14. Such content generally comprises graphics files but may comprise any form of multimedia content for which it is important or desired to ensure secure delivery to users 14.

4. Register Each Content File

For each content file received by the server 18 from the content provider 20, the server 18 registers the file and maintains registration records in its database.

In one embodiment of the present invention, registration of a content file entails: (i) creating a server digital signature of the file using the private key corresponding to the public key embedded in the consumer application; and (ii) storing the server digital signature and the corresponding content file name. As explained in more detail below, this registration information allows the client 16 to verify that the content of the file it receives from the server 18 is identical to the content of the file from which the server digital signature was generated.

In a further embodiment of the present invention, registration of a content file also entails: (iii) creating a secondary digital signature from the server digital signature and the corresponding content file name, again using the private key corresponding to the public key embedded in the consumer application; and (iv) storing the secondary digital signature with the corresponding server digital signature and content file name, preferably in a vault separate from, but accessible by, the server 18.

One of the advantages of storing all of the cryptographic registration information in a vault separate from the server 18 is that it ensures that a hacker who successfully accesses the server 18 would be unable to generate a file having valid registration information. In other words, the server digital signature detects that the hacker has modified the content of the registered file and the secondary digital signature detects that the hacker has modified the name of the content file. In practice, the secondary digital signature allows the server 18 to authenticate the content file accessed from the vault prior to transmitting to the client 16. In particular, the server 18 can use the public key to validate the secondary digital signature. If this validation is unsuccessful, the server 18 recognizes that the content file has been modified in some manner.

5. Request Web Page

The user 14 issues a command to the client 16 to request a specific Web page for display.

6. Request Content for Web Page

Using the consumer application received from the server 18 and installed on the client 16, the client 16 commands the server 18 to transmit the content necessary for displaying the requested Web page.

7. Assemble and Transmit List of Files for Building Web Page and Corresponding Server Digital Signatures

The server 18 receives the command from the client 16 requesting the content necessary for displaying the requested Web page, and determines the individual content files containing such content (alternatively, the client 16 can determine the list of files and transmit such a list to the server 18). The server 18 then accesses the vault and retrieves the cryptographic registration information for each individual content file. Finally, the server 18 transmits this retrieved information to the client 16.

In one embodiment of the present invention, the cryptographic information accessed and retrieved from the vault includes the file name, the server digital signature, and the secondary digital signature for each content file. Once this registration information is retrieved, the server 18 authenticates the identity of the content files by using the public key to validate both the secondary digital signature and the server digital signature retrieved from the vault. If any of these digital signatures cannot be successfully validated, then the server 18 recognizes that the content file is not necessarily authentic. In such case, the server 18 would not allow the unauthenticated content file to be displayed to the user 14.

8. Query Local Storage for Files Already Resident

The client 16 receives the list of individual content files and the associated registration information, and queries its local storage to determine if the names of any of the individual content files in this list match the file names which are already resident locally

9. Validate Server Digital Signatures

For each individual content file that already resides locally, the client 16 uses the public key embedded in the consumer application to validate each individual server digital signature received from the server 18. For any local content file whose server digital signature is successfully validated, the client 16 tags that local file because it has been authenticated and verified and can thus be safely used when displaying the Web page. This improves speed and efficiency by preventing the need to receive a duplicate content file from the server 18.

10. Transmit Modified List

For any local content file whose server digital signature has been successfully validated, the client 16 tags that local file for use when displaying the Web page. Furthermore, the client 16 creates a modified list by removing that file from the original list of content files received from the server 18. Once the modified list is complete (i.e., all of the authenticated and verified local content files have been removed), the client 16 transmits this modified list of necessary content files back to the server 18.

11. Transmit Files in Modified List

At this point, the server 18 transmits to the client 16 the actual content files referenced in the modified list received from the client 16. Note that it is not necessary to transmit the registration information for these content files because such information has already been transmitted to the client 16 during an earlier step.

12. Validate Server Digital Signatures

For each actual content file received from the server 18, the client 16 uses the public key embedded in the consumer application to validate each individual server digital signature received from the server 18.

13. Display Web Page If All Digital Signatures Match

If the server digital signature for every content file has been successfully validated, then the consumer application installed on the client 16 will compile the content and display the Web page to the user 14. However, if there are any content files whose server digital signatures could not be successfully validated, then the consumer application and the client 16 will not display any of the Web page to the user 14. In one embodiment, the client 16 notifies the server 18 to retransmit the non-validated content files and returns to the prior step of validating the server digital signatures. In another embodiment, the consumer application and client 16 can display an error message to the user 14 that provides notification that the content of the requested Web page could not be verified and/or authenticated.

Note that in any embodiment, the client 16 may return to the server 18 a list of the digital signatures or the hashes of each of the received files as a record of the displayed information for later auditing and verifying of the delivered content.

With respect to the detailed description herein, it should be noted that the language sometimes refers to a “graphics file” but that this embodiment and the invention as a whole is applicable to any type of content (e.g., text, audio, multimedia, etc.) for which secure transmission is desired.

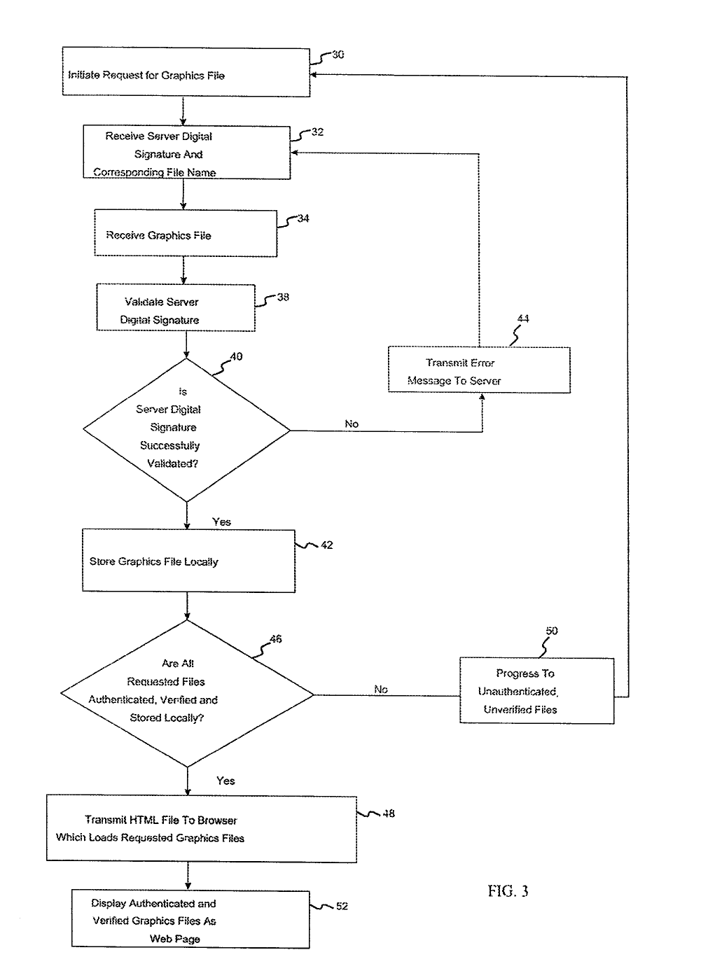

Referring now to FIG. 3, a flow chart is shown which demonstrates one embodiment for one aspect of the decision process. Specifically, the flow chart of FIG. 3 demonstrates the decision process that the client 16 follows after the user 14 has selected a Web page to display and has entered this command into the client 16.

The client 16 begins in step 30 by transmitting a command to the server 18 which requests the transmission of one of the graphics files necessary for displaying the Web page requested by the user 14. At step 32 and in response to the client's command, the server 18 accesses its vault of cryptographic registration information (the file name and the server digital signature), and transmits to the client 16 the cryptographic registration information corresponding to the graphics file requested by the client 16. The client 16 receives this registration information. Next, at step 34 the client 16 receiving the actual graphics file requested from the server 18.

The client 16 then conducts the verification process for the graphics file using a public key received from the server 18. In one embodiment, the server 18 transmits a consumer application (which may be a browser plug-in or a digital certificate) to the client 16 and the public key is embedded therein. To verify the graphics file, the client 16 performs step 38 by using the public key to validate the server digital signature by verifying a DSA type of signature or by decrypting an RSA type of signature so that the has can be verified.

In step 40, the client 16 takes different actions depending on the results of the validation of step 38. Specifically, if the server digital signature is successfully validated, then the decision process moves on to step 42 and thus stores the graphics file locally at the client 16. In other words, the integrity of the graphics file has been verified and can be safely stored for subsequent use in displaying the Web page. If, however, the server digital signature is not successfully validated, then the decision process moves to step 44. Step 44 causes the client 16 to transmit an error to the server 18 which indicates that verification of the graphics files was not successful. In order to repeat the verification process, step 44 then returns the decision process back to step 32 such that the client 16 again initiates a request for the same graphics file.

After the current graphics file has been verified and stored locally in steps 40 and 42, in step 46 the client 16 queries whether all files necessary for displaying the Web page have been authenticated, verified, and stored locally. If there are still graphic files which have not been authenticated and verified, then the decision process moves to step 50 which loops the decision process back to step 30 such that the client 16 can initiate a request for one of the remaining graphics files that have not yet been authenticated, verified, and stored locally. If all graphics files have been authenticated, verified, and stored locally, then the decision process moves to the final two steps.

Once client 16 confirms that all files necessary for displaying the Web page have been authenticated, verified, and stored locally, client 16 performs steps 48 and 52. Specifically, in step 48 the consumer application installed on the client 16 transmits the HTML command (or a command in another language) which accesses and retrieves the graphics files that have now been stored locally at the client 16. In step 52, the authenticated graphics files are then displayed to the user 14 in the form of a Web page.

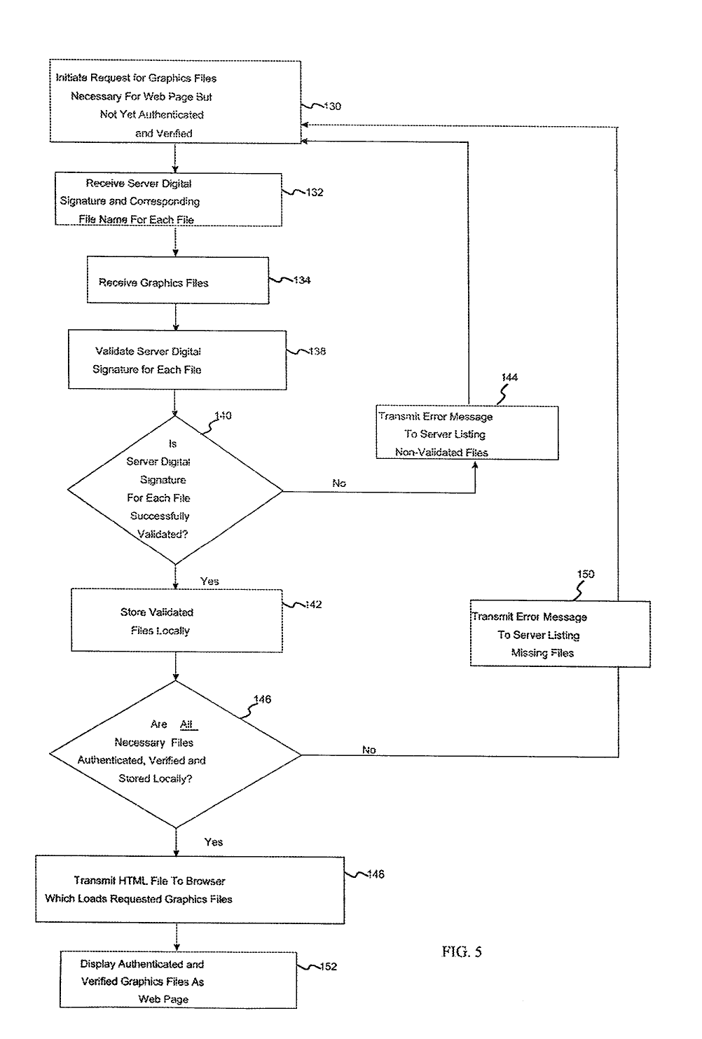

With respect to FIG. 3 and the above detailed description of FIG. 3, it should be noted that the language refers to a “graphics file” but that this embodiment and the invention as a whole is applicable to any type of content for which secure transmission is desired. Furthermore, it should also be noted that the language describes the decision process for authenticating and verifying a single file at a time. According to this embodiment, the same process would occur in a serial progression until every necessary file has been successfully authenticated and verified, at which point the Web page would be displayed to the user 14. Alternatively, it is also possible and sometimes preferable to perform such a decision process in a parallel progression as illustrated in FIG. 5. As can be seen, the steps of FIG. 5 closely mimic the steps of FIG. 3 but receive and authenticate multiple files according to a batch process.

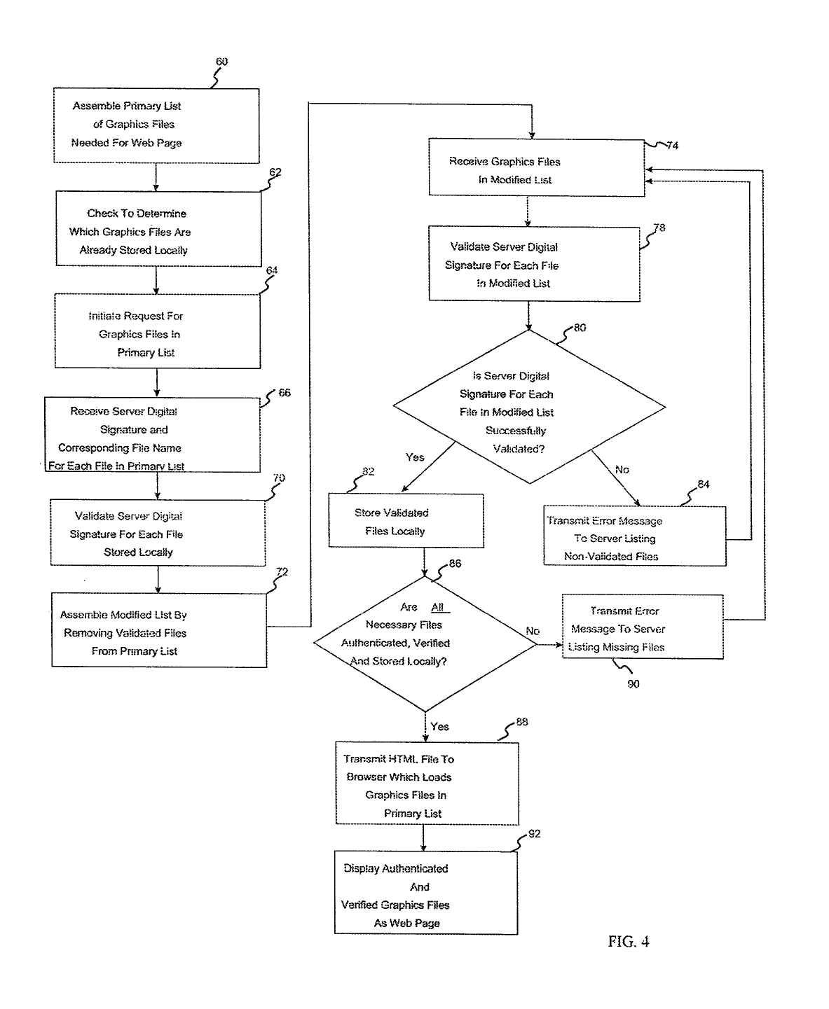

In addition, the decision processes of FIGS. 3 and 5 describe embodiments of the present invention which do not check the client's local storage to determine whether any authentic copies of the necessary content files are already resident. In another embodiment described in FIG. 4, a flow chart is shown demonstrating a decision process adapted from FIG. 5 which incorporates this feature that improves the efficiency and speed with which an authenticated and verified Web page can be displayed (note, however, that the process of FIG. 3 can also be easily adapted to incorporate the same feature).

As shown in FIG. 4 (which begins after the user 14 has selected a Web page to display and has entered this command into the client 16), in step 60 the client 16 receives the command from the user 14 and determines the exact files needed before the requested Web page can be displayed. However, in an alternative to step 60, the client 16 can transmit to the server 18 the Web page display command, and receive from the server 18 the primary list of graphics files necessary to display such Web page.

In step 62, the client 16 accesses its own local storage to determine if any files identified in the primary list are already resident locally.

Regardless of whether client 16 finds any locally stored files that are relevant in step 62, in step 64 the client 16 transmits a command to the server 18 requesting the transmission of all of the graphics files necessary for displaying the Web page requested by the user 14. Furthermore, step 66 causes the server 18 to transmit and the client 16 to receive the cryptographic registration information for each file contained in the primary list. In one embodiment, this cryptographic registration information is the server digital signature and the corresponding file name for each graphics file identified in the primary list.

In steps 70 and 72, the client 16 determines whether any of the graphics files found locally can be authenticated and verified such that it becomes unnecessary for the server 18 to transmit the actual graphics files. Specifically, client 16 performs step 70 using a public key provided by the server 18. In one embodiment, this public key is transmitted to the client 16 by embedding it in a consumer application transmitted by the server 18 which is installed on the client 16 and used to communicate with the server 18. However, it does not matter how the public key is provided to the client 16 as long as the client 16 has access to the public key. In step 70, the client 16 uses this public key to validate the server digital signatures received from the server 18 during step 66. In step 72 it is determined which files having a validated server digital signature have been successfully authenticated and verified. As a result, in step 72 a modified list is created which removes from the primary list any such graphics files that have already been authenticated and verified. The result is that the server 18 can be more efficiently utilized by eliminating the transmission of graphics files already resident locally. In addition, it may also be desirable in some situations to delete any locally stored files whose server digital signatures are not successfully validated. This deletion can prevent the subsequent inadvertent use of such a non-authenticated, locally stored file.

After creating the modified list by removing the authenticated and verified files from the primary list, in step 74 the client 16 receives from the server 18 the actual graphics files contained in the modified list.

Steps 78 and 80 the client 16 authenticates and verifies the graphics files received from the server 18. In step 78, the client 16 uses the public key to validate the server digital signature received from the server 18 for each file in the modified list. Finally, the client 16 in step 80 acts on the results of the validation of step 78. For each graphics file whose server digital signature has been successfully validated, the decision process moves on to step 82. If, however, any of the server digital signatures are not successfully validated, then the decision process moves to step 84. In step 84, the client 16 transmits an error message to the server 18 which lists the files which were not successfully authenticated and verified. Furthermore, step 84 returns the decision process to step 74 such that client 16 can repeat the request for such unauthenticated graphics files.

After a requested graphics files has been successfully authenticated and verified, the decision process moves to step 82 such that the authenticated and verified graphics file (i.e., a graphics file having a successfully validated server digital signature) is stored locally on the client 16 in preparation for displaying the Web page.

After locally storing one or more graphics files in step 82, step 86 requires that the client 16 query whether all files necessary for displaying the Web page have been authenticated, verified, and stored locally. If there are still any graphics files identified in the primary list which have not been authenticated and verified, then the decision process moves to step 90 which loops the decision process back to step 74 and identifies to the server 18 the remaining graphics files that have not yet been authenticated, verified, or stored locally. If all graphics files have been authenticated, verified, and stored locally, then the decision process moves to the final two steps.

Once client 16 confirms that all files necessary for displaying the Web page have been authenticated, verified, and stored locally, client 16 performs steps 88 and 92. Specifically, in step 88 the consumer application installed on the client 16 transmits the HTML command which accesses and retrieves the graphics files that have now been stored locally at the client 16 (this command can also be sent using a format or technique other than HTML if desired). In step 92, the graphics files are then displayed to the user 14 in the form of a Web page.

A batch file process is described in FIG. 5. The client 16 begins in step 130 by transmitting a command to the server 18 which requests the transmission for all of the graphics files necessary for displaying the Web page requested by the user 14. At step 132 and in response to the client's command, the server 18 accesses its vault of cryptographic registration information (the file name and the server digital signature), and transmits to the client 16 the cryptographic registration information corresponding to the graphics files requested by the client 16. The client 16 receives this registration information. Next, at step 134 the client 16 receiving the actual graphics files requested from the server 18.

The client 16 then conducts the verification process for the graphics files using a public key received from the server 18. As noted above, the server 18 transmits a consumer application (or a digital certificate) to the client 16 and the public key is embedded therein. To verify the graphics files, the client 16 performs step 138 by using the public key to validate the server digital signature by verifying a DSA type of signature or by decrypting an RSA type of signature so that the hash can be verified.

In step 140, the client 16 takes different actions depending on the results of the validation of step 138. Specifically, if the server digital signature is successfully validated for all files, then the decision process moves on to step 142 and thus stores the graphics file locally at the client 16. In other words, the integrity of the graphics files have been verified and can be safely stored for subsequent use in displaying the Web page. If, however, the server digital signature is not successfully validated for any file, then the decision process moves to step 144. In step 144 the client 16 transmits an error to the server 18 which indicates that verification of the graphics files was not successful. In order to repeat the verification process, step 144 then returns the decision process back to step 130 such that the client 16 again initiates a request for the graphics file.

After the current graphics files have been verified and stored locally in steps 140 and 142, step 46 the client 16 queries whether all files necessary for displaying the Web page have been authenticated, verified, and stored locally. If there are still graphics files which have not been authenticated and verified, then the decision process moves to step 150 which loops the decision process back to step 130 such that the client 16 can initiate a request for the remaining graphics files that have not yet been authenticated, verified, or stored locally. If all graphics files have been authenticated, verified, and stored locally, then the decision process moves to the final two steps.

Once client 16 confirms that all files necessary for displaying the Web page have been authenticated, verified, and stored locally, client 16 performs steps 148 and 152. Specifically, in step 148 the consumer application installed on the client 16 transmits the HTML command (or a command in another language) which accesses and retrieves the graphics files that have now been stored locally at the client 16. In step 152, the authenticated graphics files are then displayed to the user 14 in the form of a Web page.

In all embodiments, it should be noted that the client 16 operated by the user 14 can be any computing device which is capable of operating over a network. For instance, this invention is applicable to the use of desktop computers, laptop computers, handheld devices, mobile phones, and any other type of networked device in which the security and integrity of transmitted content is important. Furthermore, although one embodiment of this invention is for operating over a public network such as the Internet, it is equally applicable for providing additional security when operating over a private network or intranet.

The technique of this invention is advantageous to any application for which secure online content delivery is important. In particular, the potential applications include but are not limited to online banking, online stock transactions, and online commerce for purchasing goods and services (i.e., event tickets, travel tickets, gift certificates, vouchers, etc.).

Although several embodiments of the invention have been illustrated in the accompanying drawings and described in the foregoing Detailed Description, it will be understood that the invention is not limited to the embodiments disclosed, but is capable of numerous rearrangements, modifications and substitutions without departing from the scope of the invention.

What is claimed is:

1. A method of authenticating and verifying that a content file accessed by a computer is identical to the content file originally received by the computer, comprising the steps of:
registering a content file received at the computer, comprising:
generating a first digital signature of the content file, using a first key;
generating a secondary digital signature of the first digital signature and a file name of the content file, using the first key; and
storing the content file, the first digital signature, the file name, and the secondary digital signature;
accessing the stored content file, the stored first digital signature, the stored file name, and the stored secondary digital signature;
validating the first digital signature of the stored content file, using a second key corresponding to the first key; and
validating the secondary digital signature of the stored content file, using the second key.

2. A method of authenticating and verifying the integrity of a content file delivered from a server computer to a client computer over a network, comprising the steps of:
registering a content file by generating unique registration information using a first key;
storing the content file and the registration information on the server computer;
accessing the content file and the registration information in response to a request from the client computer;
authenticating the integrity of the content file and the registration information accessed by the server computer by use of a second key; and
transmitting the authenticated content file and registration information to the client computer.

3. A method of authenticating and verifying the integrity in accordance with claim 1, wherein the first key is a private key, the second key is a public key, and including the step of providing the client computer with a public key corresponding to a private key maintained by the server computer.

4. A method of authenticating and verifying the integrity of a content file in accordance with claim 2, wherein the client computer can use the public key to generate registration information unique to the content file transmitted from the server computer and can validate the registration information generated using the public key relative to the registration information transmitted from the server computer.

5. A method of authenticating and verifying the integrity of a content file in accordance with claim 2, wherein the step of providing the client computer with a public key comprises transmitting to the client computer a consumer application having the public key embedded therein.

6. A method of authenticating and verifying the integrity of a content file in accordance with claim 2, wherein the step of providing the client computer with a public key comprises transmitting to the client computer a digital certificate having the public key embedded therein.

7. A method of authenticating and verifying the integrity of a content file in accordance with claim 2, wherein the step of registering a content file by generating unique registration information comprises:
generating a server digital signature of the content file, using the private key; and
storing the server digital signature along with a file name of the content file.

8. A method of authenticating and verifying the integrity of a content file in accordance with claim 7, wherein the step of authenticating the integrity of the content file and the registration information comprises:
validating the server digital signature accessed by the server computer, using the public key.

9. A method of authenticating and verifying the integrity of a content file in accordance with claim 7, wherein the step of registering a content file by generating unique registration information further comprises:
generating a secondary digital signature of the server digital signature and the file name, using the private key; and
storing the secondary digital signature along with the server digital signature and the file name.

10. A method of authenticating and verifying the integrity of a content file in accordance with claim 9, wherein the step of authenticating the integrity of the content file and the registration information comprises:
validating the secondary digital signature accessed by the server computer, using the public key.

11. A method of authenticating and verifying the integrity of a content file in accordance with claim 10, wherein the step of authenticating the integrity of the content file and the registration information further comprises:
validating the server digital signature accessed by the server computer, using the public key.

12. A method of authenticating and verifying the integrity of content delivered over a public network in response to a request transmitted from a client computer to a server computer, comprising the steps of:
providing the client computer with a public key corresponding to a private key maintained by the server computer;
generating server registration information unique to each content file stored on the server computer, using the private key;
assembling a primary list identifying each content file responsive to the client computer's request;
transmitting to the client computer the primary list and the server registration information associated with each content file identified in the primary list;
authenticating and verifying any content files identified in the primary list which are already resident on the client computer, comprising the steps of:
assembling a matching list identifying each content file identified in the primary list which is stored on the client computer and a non-matching list identifying each content file identified in the primary list which is not stored on the client computer;
validating the server registration information received from the server computer for each content file identified in the matching list, using the public key; and
removing from the matching list and adding to the non-matching list each content file identified in the matching list for which the server registration information is not successfully validated;
transmitting to the client computer each content file identified in the non-matching list; and
validating the server registration information for each content file received from the server computer and identified in the non-matching list, using the public key.

13. A method of authenticating and verifying the integrity of content delivered over a public network in accordance with claim 12, wherein the step of providing the client computer with a public key comprises transmitting to the client computer a consumer application having the public key embedded therein.

14. A method of authenticating and verifying the integrity of content delivered over a public network in accordance with claim 12, wherein the step of providing the client computer with a public key comprises transmitting to the client computer a digital certificate having the public key embedded therein.

15. A method of authenticating and verifying the integrity of a content file in accordance with claim 12, wherein the step of generating server registration information unique to each content file comprises:
generating a server digital signature of each content file, using the private key; and
storing the server digital signature along with a corresponding file name for each content file.

16. A method of authenticating and verifying the integrity of a content file in accordance with claim 15, wherein, prior to the step of transmitting to the client computer the primary list and the server registration information associated with each content file identified in the primary list, the method further comprises the step of:
validating the server digital signature of each content file identified in the primary list and stored on the server computer, using the public key.

17. A method of authenticating and verifying the integrity of a content file in accordance with claim 15, wherein the step of generating server registration information unique to each content file further comprises
generating a secondary digital signature of each server digital signature and each corresponding file name, using the private key; and
storing each secondary digital signature along with the corresponding server digital signature and file name.

18. A method of authenticating and verifying the integrity of a content file in accordance with claim 17, wherein, prior to the step of transmitting to the client computer the primary list and the server registration information associated with each content file identified in the primary list, the method further comprises the step of:
authenticating the integrity of each content file identified in the primary list and stored on the server computer, comprising the steps of:
validating the server digital signature of each content file identified in the primary list and stored on the server computer, using the public key; and
validating the secondary digital signature of each content file identified in the primary list and stored on the server computer, using the public key.

19. A method of browsing the web by requesting content from a server computer over a public network and displaying the content to a user on a client computer only after the integrity of such content has been authenticated and verified, comprising the steps of:
transmitting a request to the server computer for content necessary to build a displayable web page;
receiving from the server computer a primary list identifying each file necessary to build the web page and a server digital signature uniquely associated with each file identified in the primary list;
validating the server digital signature for each file stored locally on the client computer which is identified in the primary list;
transmitting to the server computer a secondary list identifying each file identified in the primary list which is not stored locally on the client computer or for which the server digital signature is not successfully validated;
receiving from the server computer each file identified in the secondary list;
validating the server digital signature for each file received from the server computer and identified in the secondary list; and
if the server digital signature for each file is validated, displaying on the client computer a web page incorporating the content of each file identified in the primary list if the server digital signature is successfully validated for every file received from the server computer and identified in the secondary list.

20. A method of browsing the web in accordance with claim 19, further comprising the step of:
deleting each file stored locally on the client computer for which the server digital signature is not successfully validated.

21. A method of browsing the web in accordance with claim 19, further comprising the step of:
displaying on the client computer an error message if the server digital signature is not successfully validated for any file received from the server computer and identified in the secondary list.

22. A method of browsing the web in accordance with claim 20, further comprising the step of:
transmitting to the server computer an error list identifying each file identified in the secondary list for which the server digital signature is not successfully validated.

23. A method of browsing the web in accordance with claim 22, further comprising the steps of:
receiving from the server computer each file identified in the error list;
validating the server digital signature for each file received from the server computer and identified in the error list; and
displaying on the client computer a web page incorporating the content of each file identified in the primary list if the server digital signature is successfully validated for every file received from the server computer and identified in the error list.

24. A web content delivery system for delivering web content from a server computer to a client computer over a public network and displaying the content on the client computer only after the integrity of such content has been authenticated and verified, comprising the steps of:
providing the client computer with a public key which corresponds to a private key maintained at the server computer;
generating at the server computer cryptographic registration information for each content file stored on the server computer, comprising the steps of:
generating a server digital signature of each content file stored on the server computer, using the private key;
generating a secondary digital signature of each server digital signature and corresponding file name, using the private key; and
storing on the server computer each file name along with the corresponding server digital signature and secondary digital signature;
transmitting from the client computer to the server computer a request for content necessary to build a displayable web page;
assembling at the server computer a primary list identifying each content file responsive to the request for content;
authenticating and verifying any content files identified in the primary list which are stored on the server computer, comprising the steps of:
validating the server digital signature of each content file identified in the primary list, using the private key; and
validating the secondary digital signature of each content file identified in the primary list;
transmitting from the server computer to the client computer the primary list and the server digital signature of each content file identified in the primary list;
authenticating and verifying any content files identified in the primary list which are already resident on the client computer, comprising the steps of:
assembling a matching list identifying each content file identified in the primary list which is stored on the client computer and a non-matching list identifying each content file identified in the primary list which is not stored on the client computer;
validating the server digital signature of each content file stored on the client computer and identified in the matching list, using the public key; and
removing from the matching list and adding to the non-matching list each content file identified in the matching list for which the server digital signature is not successfully validated;
transmitting from the server computer to the client computer each content file identified in the non-matching list; and
validating the server digital signature of each content file received from the server computer and identified in the non-matching list, using the public key.

25. A system for verification of file content which is transmitted from a server to a client through a network, comprising:
said server having therein a server program for:
(a) registering a plurality of files which comprise said content by producing registration information which includes a digital signature for each said file by use of a private key, and
(b) storing said files and said registration information,
(c) sending a list said files and said registration information to said client when said file content is requested, and
(d) sending the ones of said files requested by said client to said client via said network,
said client of said server having therein a client program for:
(a) requesting said file content via said network,
(b) upon receiving said list of said files and said registration information, detecting the presence of any of said files on said list in local storage for said client,
(c) for said local files, which are on said list and located in said local storage, verifying said local files by use of said registration information, and
(d) requesting from said server the ones of said files on said list which were not verified by said client.

26. An article of manufacture comprising a computer program carrier readable by a computer and embodying one or more instructions executable by the computer to perform steps for authenticating and verifying that a content file accessed by a server computer is identical to the content file originally received by the server computer, comprising:
registering a content file received at the computer, comprising:
generating a first digital signature of the content file, using a first key;
generating a secondary digital signature of the first digital signature and a file name of the content file, using the first key; and
storing the content file, the first digital signature, the file name, and the secondary digital signature;
accessing the stored content file, the stored first digital signature, the stored file name, and the stored secondary digital signature;
validating the first digital signature of the stored content file, using a second key corresponding to the first key; and
validating the secondary digital signature of the stored content file, using the second key.

27. An article of manufacture comprising a computer program carrier readable by a computer and embodying one or more instructions executable by the computer to perform steps for authenticating and verifying the integrity of a content file delivered from a server computer to a client computer over a network, comprising:
registering a content file by generating unique registration information using a first key;
storing the content file and the registration information on the server computer;
accessing the content file and the registration information in response to a request from the client computer;
authenticating the integrity of the content file and the registration information accessed by the server computer by use of a second key; and
transmitting the authenticated content file and registration information to the client computer.

28. An article of manufacture comprising a computer program carrier readable by a computer and embodying one or more instructions executable by the computer to perform steps for browsing the web by requesting content from a server computer over a public network and displaying the content to a user on a client computer only after the integrity of such content has been authenticated and verified, comprising:
transmitting a request to the server computer for content necessary to build a displayable web page;
receiving from the server computer a primary list identifying each file necessary to build the web page and a server digital signature uniquely associated with each file identified in the primary list;
validating the server digital signature for each file stored locally on the client computer which is identified in the primary list;
transmitting to the server computer a secondary list identifying each file identified in the primary list which is not stored locally on the client computer or for which the server digital signature is not successfully validated;
receiving from the server computer each file identified in the secondary list;
validating the server digital signature for each file received from the server computer and identified in the secondary list; and
if the server digital signature for each file is validated, displaying on the client computer a web page incorporating the content of each file identified in the primary list if the server digital signature is successfully validated for every file received from the server computer and identified in the secondary list.

29. An apparatus for authenticating and verifying a content file, comprising:
a computer in a computer network; and
one or more computer programs, performed by the computer, for registering a content file received at the computer, comprising:
generating a first digital signature of the content file, using a first key;
generating a secondary digital signature of the first digital signature and a file name of the content file, using the first key; and
storing the content file, the first digital signature, the file name, and the secondary digital signature;
accessing the stored content file, the stored first digital signature, the stored file name, and the stored secondary digital signature;
validating the first digital signature of the stored content file, using a second key corresponding to the first key; and
validating the secondary digital signature of the stored content file, using the second key.

30. An apparatus for authenticating and verifying integrity of a content file, comprising:
a server computer in a computer network;
a client computer connected to the server computer via the computer network; and
one or more computer programs, performed by the server computer, for:
registering a content file by generating unique registration information using a first key;
storing the content file and the registration information on the server computer;
accessing the content file and the registration information in response to a request from the client computer;
authenticating the integrity of the content file and the registration information accessed by the server computer by use of a second key; and
transmitting the authenticated content file and registration information to the client computer.

31. An apparatus for browsing the web by requesting content from a server computer over a public network and displaying the content to a user on a client computer only after the integrity of such content has been authenticated and verified, comprising, comprising:
a server computer in a computer network;
a client computer connected to the server computer via the computer network; and
one or more computer programs, performed by the client computer, for:
transmitting a request to the server computer for content necessary to build a displayable web page;
receiving from the server computer a primary list identifying each file necessary to build the web page and a server digital signature uniquely associated with each file identified in the primary list;
validating the server digital signature for each file stored locally on the client computer which is identified in the primary list;
transmitting to the server computer a secondary list identifying each file identified in the primary list which is not stored locally on the client computer or for which the server digital signature is not successfully validated;
receiving from the server computer each file identified in the secondary list;
validating the server digital signature for each file received from the server computer and identified in the secondary list; and
if the server digital signature for each file is validated, displaying on the client computer a web page incorporating the content of each file identified in the primary list if the server digital signature is successfully validated for every file received from the server computer and identified in the secondary list.
